(19) United States
(12) Patent Application Publication
(10) Pub. No.: US 2026/0268431 A1
(43) Pub. Date: Sep. 10, 2026

(54) ROAD IMPROVEMENT ASSISTANCE SYSTEM AND ROAD IMPROVEMENT ASSISTANCE METHOD

(71) Applicant: HONDA MOTOR CO., LTD., Tokyo (JP)

(72) Inventors: Atsuya Ishikawa, Wako-shi (JP); Ryota Mimura, Wako-shi, Saitama (JP); Takayuki Kawabuchi, Wako-shi (JP)

(21) Appl. No.: 19/446,480

(22) Filed: Jan. 12, 2026

(30) Foreign Application Priority Data
Mar. 4, 2025 (JP) 2025-033831

(51) Int. Cl. G06Q 50/26; G06F 16/29; G08G 1/09

(52) U.S. Cl. CPC G06Q 50/26; G06F 16/29; G08G 1/09

(57) ABSTRACT

A road improvement assistance system includes a countermeasure planning database that stores road countermeasure data, accident information including an induction factor of an accident predicted from the road features, and a countermeasure plan for eliminating the induction factor of the accident are associated with each other. The road improvement assistance system includes a processor that acquires an image of surroundings of a road of interest, extracts a road feature group including at least one road feature of the road of interest from the image, and generates information including an induction factor of interest and a countermeasure plan of interest by referring to the countermeasure planning database, the induction factor of interest being an induction factor of an accident predicted for the road of interest, the countermeasure plan of interest being a countermeasure plan for eliminating the induction factor of interest.

### INCORPORATION BY REFERENCE

The present application claims priority under 35 U.S.C. § 119 to Japanese Patent Application No. 2025-033831 filed on Mar. 4, 2025. The content of the application is incorporated herein by reference in its entirety.

### BACKGROUND OF THE INVENTION

### Field of the Invention

The present invention relates to a road improvement assistance system and a road improvement assistance method.

### Description of the Related Art

In recent years, there have been increasing efforts to provide access to a sustainable transportation system with consideration for people in vulnerable positions among traffic participants. In order to achieve this, attention is given to research and development for further improving traffic safety and convenience through research and development relating to active safety technology.

Japanese Patent Laid-Open No. 2020-113070 discloses a road environment distinguishing device that can facilitate early improvement of the road environment. This road environment distinguishing device analyzes a video of a vehicle's surroundings captured by an on-vehicle camera, and transmits location information about signs or mirrors having poor visibility to an information requester.

Japanese Patent Laid-Open No. 2005-234848 discloses a road traffic control system to reduce the possibility of repeated occurrences of accidents due to traffic conditions. According to this road traffic control system, the occurrence of an accident on a road is detected and recorded, and, when similar accidents are recorded repeatedly, the factors of the accidents are analyzed, and an improvement proposal for the road shape and the like is output.

### SUMMARY OF THE INVENTION

For active safety technology, there is a problem in efficiently proposing objective countermeasure plans for roads in advance to prevent occurrence of accidents, without the time and effort required to dispatch experts, or the like.

In order to solve the above-described problem, the purpose of the present application is to realize a road improvement assistance system and a road improvement assistance method that can efficiently propose objective countermeasure plans for roads in advance to prevent occurrence of accidents. This will eventually contribute to the development of a sustainable transport system.

One aspect of the present invention is a road improvement assistance system including: a countermeasure planning database that stores road countermeasure data in which information about road features that characterize a road, accident information including an induction factor of an accident predicted from the road features, and a countermeasure plan for eliminating the induction factor of the accident are associated with each other; an extraction unit that acquires an image of surroundings of a road of interest that is a road at a location of interest, and extracts a road feature group including at least one road feature of the road of interest from the image; a generation unit that, based on the road feature group extracted from the image, generates, as provision information, information including an induction factor of interest and a countermeasure plan of interest by referring to the countermeasure planning database, the induction factor of interest being an induction factor of an accident predicted for the road of interest, the countermeasure plan of interest being a countermeasure plan for eliminating the induction factor of interest; and an information output unit that outputs the provision information.

Another aspect of the present invention is a road improvement assistance method to be performed by a computer of a road improvement assistance system having a countermeasure planning database that stores road countermeasure data in which information about road features that characterize a road, accident information including an induction factor of an accident predicted from the road features, and a countermeasure plan for eliminating the induction factor of the accident are associated with each other, the road improvement assistance method including: an extraction step for acquiring an image of surroundings of a road of interest that is a road at a location of interest, and extracting a road feature group including at least one road feature of the road of interest from the image; a generation step for, based on the road feature group extracted from the image, generating, as provision information, information including an induction factor of interest and a countermeasure plan of interest by referring to the countermeasure planning database, the induction factor of interest being an induction factor of an accident predicted for the road of interest, the countermeasure plan of interest being a countermeasure plan for eliminating the induction factor of interest; and an output step for outputting the provision information.

According to the aspects of the present invention, it is possible to efficiently propose objective countermeasure plans for roads in advance to prevent occurrence of accidents.

### BRIEF DESCRIPTION OF THE DRAWINGS

FIG. 1 is a diagram showing a configuration of a road improvement assistance system according to one embodiment of the present invention;

FIG. 2 is a view showing one example of a road feature group of a road of interest;

FIG. 3 is a view showing one example of provision information for the road of interest; and

FIG. 4 is a flowchart showing one example of a procedure of a road improvement assistance method that is executed by the road improvement assistance system.

### DETAILED DESCRIPTION OF THE INVENTION

Hereinafter, an embodiment of the present invention will be described with reference to the drawings.

### 1. Configuration of Road Improvement Assistance System

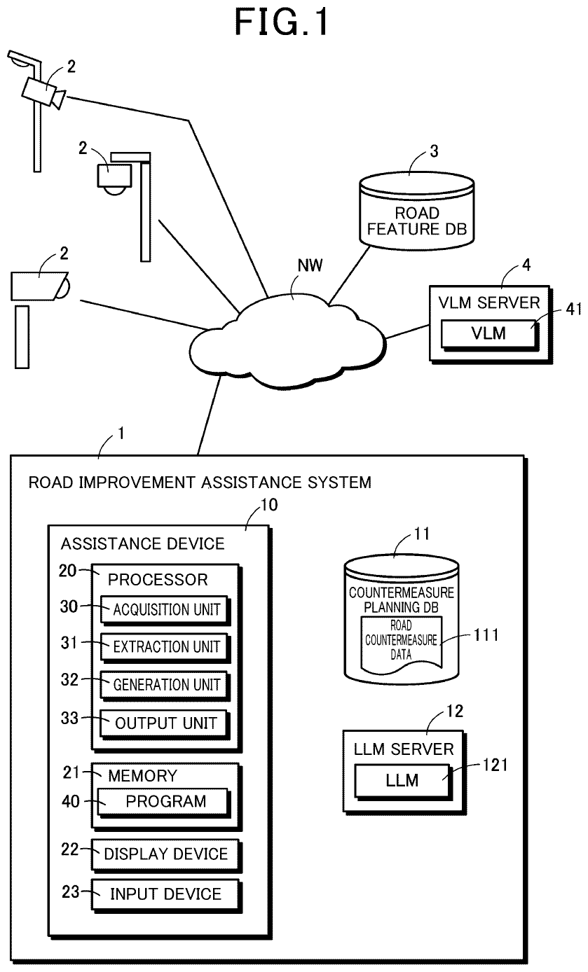

FIG. 1 is a diagram showing a configuration of a road improvement assistance system 1 according to one embodiment of the present invention.

The road improvement assistance system 1 is communicatively connected via a communication network NW to at least one surveillance camera 2 installed in the surroundings of a road, and a road feature database (DB) 3 serving as an external knowledge base. The road improvement assistance system 1 may further be communicatively connected via the communication network NW to a VLM server 4 that provides an AI function using vision language models (VLM), which performs image-and-text integration processing.

The surveillance camera 2 can be a street camera, a security camera, and/or a road surveillance camera installed in the surroundings of roads in a city. The road improvement assistance system 1 can acquire, directly from the surveillance camera 2 or via a server that manages the surveillance camera 2, an image captured by the surveillance camera 2.

The road feature database 3 is a database which stores a geographical location and road features of a road located at the geographical location in association with each other. The road feature database 3 can be, for example, a database of a geographic information system (GIS) managed by a public organization (such as a national or local government) or a private organization (such as a company or an academic organization).

The road improvement assistance system 1 includes an assistance device 10 that is a computer, and a countermeasure planning database 11. The road improvement assistance system 1 may also include an LLM server 12 that provides an AI function using large language models (LLM). In the present embodiment, an LLM 121 held by the LLM server 12 can be adjusted to access the countermeasure planning database 11 serving as an expert knowledge base. Consequently, the road improvement assistance system 1 can be built as a retrieval-augmented generation (RAG) system.

Communication among the assistance device 10, the countermeasure planning database 11, and the LLM server 12 is performed, for example, via an internal network of the road improvement assistance system 1. Note that this is merely one example, and communication among the assistance device 10, the countermeasure planning database 11, and the LLM server 12 may be performed via the communication network NW.

The countermeasure planning database 11 stores road countermeasure data 111 in which information about road features that characterize a road, accident information including an induction factor of an accident predicted from the road features, and a countermeasure plan for eliminating the induction factor of the accident are associated with each other. Here, the “induction factor of an accident” is any factor that induces an accident, and specific details of the induced accident are not necessarily specified.

In the road countermeasure data 111 stored in the countermeasure planning database 11, a predicted induction factor, risk level, and possibility of occurrence of an accident, and a countermeasure plan for eliminating the induction factor of the accident can be associated for each road feature or each combination of a plurality of road features. Here, the “risk level” and “possibility of occurrence” contained in the road countermeasure data 111 are the “risk level” and “possibility of occurrence” of some accident that can be induced by the induction factor, and specific details of the induced accident are not necessarily specified.

The above-described “risk level” may be represented by a predefined risk level rank. For example, such risk level ranks can be assigned such that the higher the risk level, the higher the numerical rank. As one example, the risk levels can be ranked on a five-point scale with “1” being a minor risk and “5” being an extremely severe risk.

Similarly, the above-described “possibility of occurrence” can be represented by a predefined possibility rank. For example, such possibility ranks can be assigned such that the higher the possibility of occurrence, the higher the numerical rank.

In the present embodiment, road features can be information about the configuration, condition, traffic, and/or environment of the road. Consequently, an objective countermeasure plan can be proposed based not only on the configuration of the road, but also on various road features that may affect the cognitive abilities of traffic participants.

The configuration of a road as a road feature can be information such as, for example, an intersection, a branching road, a curve, a gradient, the presence of a sign, and the number of lanes. Moreover, the condition of a road as a road feature can be the condition of the road surface of the road. Information about the traffic on a road as a road feature can be the traffic density on the road and the average speed of vehicles traveling on the road. Furthermore, information about the environment of a road as a road feature can be information such as the weather in an area in which the road is present, lighting on the road, and light reflection from surrounding buildings.

Accident information contained in the road countermeasure data 111 can include information about an induction factor of an accident and the level of possibility of occurrence of the accident. The level of possibility of occurrence of an accident can be, for example, predicted frequency of occurrence of an accident (for example, the frequency of occurrence per month), or a rank indicating a range of frequency of occurrence (for example, three ranks: high frequency, medium frequency, and low frequency).

The assistance device 10 is a computer including a processor 20, a memory 21, a display device 22, and an input device 23. The display device 22 is, for example, a liquid crystal display. The input device 23 can include a keyboard and/or a mouse. The input device 23 and the display device 22 may be configured as a touch panel. The memory 21 is formed by, for example, volatile and/or non-volatile semiconductor memory.

The processor 20 is, for example, an arithmetic processing unit such as a CPU. The processor 20 may include a ROM in which a program is written, and a RAM for temporarily storing data. The processor 20 has an acquisition unit 30, an extraction unit 31, a generation unit 32, and an output unit 33 as functional elements, or functional units.

These functional elements of the processor 20 are realized, for example, by the processor 20 of the assistance device 10 as the computer executing a program 40 stored in the memory 21. Note that the program 40 can be stored in an arbitrary computer-readable recording medium. Alternatively, it is possible to configure all or part of the functional elements of the processor 20 by hardware, including one or more electronic circuit components.

The acquisition unit 30 acquires an image of surroundings of a road of interest, which is the road at a location of interest. Hereinafter, an image of surroundings of a road of interest will be referred to as a road surroundings image. The acquisition unit 30 acquires, via the communication network NW, an image captured by the surveillance camera 2, which is installed in the surroundings of the road of interest, as a road surroundings image. Alternatively or additionally, the acquisition unit 30 may acquire, via the communication network NW, an image captured by a vehicle traveling on the road of interest or an image captured by a mobile terminal of a person in the surroundings of the road of interest, as a road surroundings image.

The extraction unit 31 acquires the road surroundings image through the acquisition unit 30, and extracts a road feature group, including at least one road feature of the road of interest, from the road surroundings image. For example, the extraction unit 31 accesses the VLM server 4, inputs the road surroundings image into the VLM 401, and acquires, as text, at least one road feature of the road (i.e., the road of interest) in the road surroundings image from the VLM 401. The extraction unit 31 can acquire a road feature group as a text group including a plurality of texts, each representing a road feature. Note that the extraction unit 31 may extract at least one road feature of the road of interest as a text group representing the road feature by an image analysis of the road surroundings image, instead of using the VLM 401.

The generation unit 32, based on the road feature group extracted from the road surroundings image, generates, as provision information, information including an induction factor of an accident predicted for the road of interest and a countermeasure plan for eliminating the induction factor by referring to the countermeasure planning database 11. Hereinafter, an induction factor of an accident predicted for the road of interest will be referred to as an induction factor of interest, and a countermeasure plan for eliminating the induction factor of interest will be referred to as the countermeasure plan of interest. In short, the provision information includes the induction factor of interest and the countermeasure plan of interest.

The generation unit 32 may access an external database, revise or supplement, and correct the road feature group extracted from the road surroundings image, based on information obtained from the external database, and generate the provision information using the corrected road feature group. In the present embodiment, one example of the external database is a road feature database 3.

The generation unit 32 can revise or supplement, and correct the road feature group extracted from the road surroundings image, based on the road features of the road of interest obtained from the road feature database 3, and generate the provision information using the corrected road feature group. Consequently, even when a road feature grasped from the current image of the road of interest contains a mistake, the mistake can be corrected using information from the road feature database that has already been created, and, therefore, the generation unit 32 can present a more accurate countermeasure plan as the countermeasure plan of interest.

Specifically, the generation unit 32 obtains road features of the road of interest as text from the road feature database 3. Then, the generation unit 32, for example, complements part of the text in a text group representing the road feature group extracted from the road surroundings image with the obtained text, or adds the obtained text to the text group, to correct the text group. Furthermore, the generation unit 32 can generate the provision information, based on the corrected text group.

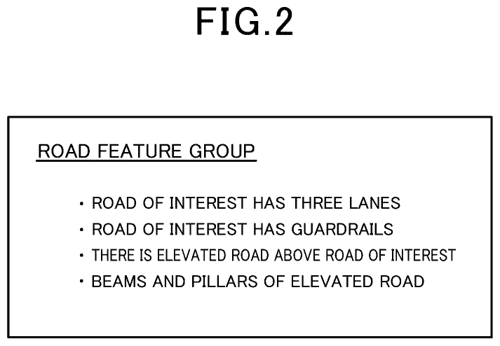

FIG. 2 is a view showing one example of a road feature group of a road of interest running under an elevated road. As shown in FIG. 2, the road feature group of the road of interest can be a list of a group of texts, each indicating one or more road features.

The generation of the provision information from the road feature group can be performed using the AI function provided by the LLM server 12. The LLM 121 of the LLM server 12 is adjusted to access the countermeasure planning database 11, which is an expert knowledge base, using, for example, retrieval-augmented generation (RAG) technology.

The generation unit 32 generates a prompt to be input to the LLM 121, from the text group representing the road feature group obtained by the extraction unit 31 or the text group representing the corrected road feature group, and inputs the generated prompt to the LLM 121, thereby causing the LLM 121 to generate the provision information. The generation unit 32 can generate and optimize a prompt for effectively utilizing the LLM by using a prompt engineering technique. For example, the generation unit 32 may use AI, such as a so-called prompt generator or a prompt generation engine, to generate the prompt.

The generation unit 32 may use an output of the LLM 121 as it is for the provision information, or may generate the provision information based on the output from the LLM 121. For the generation of the provision information based on the output from the LLM 121, for example, the generation unit 32 may generate the provision information by extracting information that meets a predetermined condition from the output of the LLM 121, or may generate the provision information by performing post-processing such as sorting the list included in the output of the LLM 121 under a predetermined condition.

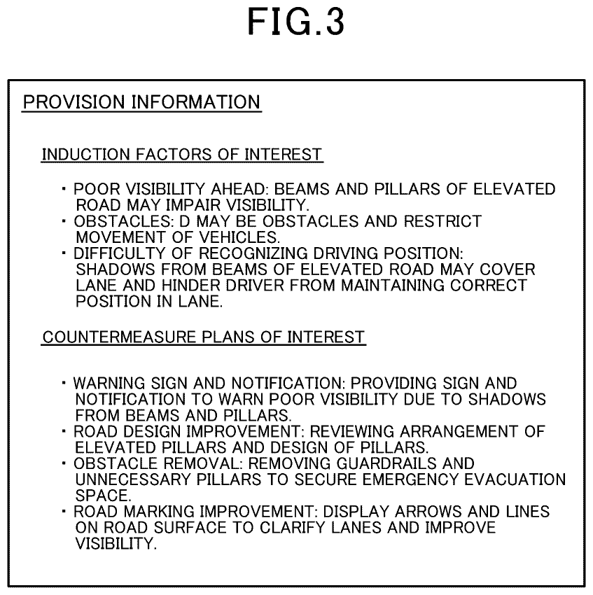

FIG. 3 is a view showing one example of the provision information. As shown in FIG. 3, the provision information can be created by a list of texts. In the example shown in FIG. 3, the provision information is formed by a list of induction factors of interest and a list of countermeasure plans of interest. One countermeasure plan may be listed as the countermeasure plan for eliminating a plurality of induction factors of interest, or a plurality of countermeasure plans of interest may be listed as the countermeasure plans for eliminating one induction factor of interest. In short, the number of induction factors of interest and the number of countermeasure plans of interest do not necessarily have to match.

Moreover, the generation unit 32 may use the road countermeasure data 111 stored in the countermeasure planning database 11 to calculate the possibility of occurrence and the risk level of an accident for each induction factor of interest, and include the calculation result in the provision information. Consequently, it is possible to objectively grasp which of a plurality of induction factors of interest should receive more attention.

As described above, in the road countermeasure data 111, a predicted induction factor, risk level and possibility of occurrence of an accident, and a countermeasure plan for eliminating the induction factor of the accident can be associated for each road feature, or each combination of a plurality of road features. Further, the risk level and the possibility of occurrence can be expressed as a risk level rank and a possibility rank, respectively.

For example, for one induction factor of interest, the generation unit 32 refers to the road countermeasure data 111 to identify one or more road features associated with the same induction factor as the induction factor of interest. The generation unit 32 extracts a road feature included in the road feature group of the road of interest from the identified one or more road features. Then, the generation unit 32 calculates a comprehensive risk level rank and a comprehensive possibility rank by respectively adding up the risk level ranks and the possibility ranks associated with the extracted road features in the road countermeasure data 111. The generation unit 32 can include, in the provision information, the calculated comprehensive risk level rank and comprehensive possibility rank as the possibility of occurrence and the risk level of the accident, respectively, for the induction factor of interest.

Alternatively, the generation unit 32 may acquire the calculation result by including, in a prompt to be input to the LLM 121, an instruction to calculate the possibility of occurrence and the risk level of an accident for each induction factor of interest according to the above procedure.

When the provision information includes a plurality of countermeasure plans of interest, the generation unit 32 may use the possibility of occurrence and the risk level of an accident for each induction factor of interest calculated as described above, and determine the priority level (or order of priority) for executing the countermeasure plans of interest, based on the possibility of occurrence or the risk level of the induction factor of interest corresponding to each of individual countermeasure plans of interest, and include the priority level of each countermeasure plan of interest in the provision information. Consequently, based on the priority level, it is possible to effectively execute the countermeasure plans of interest in order of the greatest effect on preventing the occurrence of accidents.

For example, the higher the possibility of occurrence or the risk level (for example, the higher the comprehensive possibility rank or the comprehensive risk level rank) of an induction factor of interest corresponding to each countermeasure plan of interest, the generation unit 32 can determine a higher priority level.

Alternatively, the generation unit 32 may obtain countermeasure plans of interest and the priority level of each countermeasure plan of interest from the LLM 121 by including, in the prompt to be input to the LLM 121, an instruction to determine the priority level of each countermeasure plan of interest according to the procedure.

The generation unit 32 may also generate, based on the induction factor of interest, notification information to alert traffic participants. The notification information can be generated as information directed to the traffic participants, including vehicles and pedestrians traveling on the road of interest. Consequently, it is possible to prevent the occurrence of an accident by alerting the traffic participants by the notification information until the countermeasure plan of interest is executed and completed.

For example, the generation unit 32 can generate, based on an induction factor of interest “Poor visibility ahead: beams and pillars of an elevated road may impair visibility”, the notification information containing a message “Please be aware that the beams and pillars of an elevated road may make it difficult to see traffic ahead”.

The output unit 33 outputs the provision information. For example, the output unit 33 can transmit the provision information to a predetermined organization. The organization can be, for example, a national or local government organization that oversees or plans road maintenance.

The output unit 33 may also output the notification information generated by the generation unit 32 to traffic participants traveling on the road of interest and in the surroundings of the road of interest. Specifically, the output unit 33 can display the notification information on an electronic billboard installed in the surroundings of the road of interest or in the surroundings of a road leading to the road of interest, transmit the notification information to vehicles traveling on the road of interest, and/or transmit the notification information to mobile terminals of people traveling on the road of interest.

The road improvement assistance system 1 with the above-described configuration receives an image of the surroundings of a road of interest as an input, and extracts a road feature group including at least one road feature of the road of interest from the input image. Then, the road improvement assistance system 1 refers to the countermeasure planning database 11 in which a road feature is associated with a predicted accident and a countermeasure plan, generates provision information including details of a predicted accident that are predicted for a road of interest from the road feature group of the road of interest, and a countermeasure plan of interest for the accident, and outputs the provision information.

Consequently, the road improvement assistance system 1 can efficiently propose, based on the road features of a road of interest grasped from the road surroundings image, an objective countermeasure plan in advance to prevent the occurrence of accidents on the road of interest.

### 2. Operation of Road Improvement Assistance System 1

Next, the procedure of an operation of the road improvement assistance system 1 will be described.

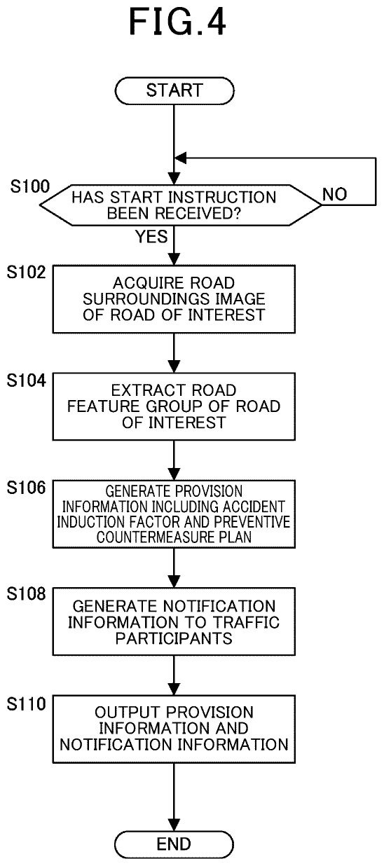

FIG. 4 is a flowchart showing one example of the procedure of a road improvement assistance method that is executed by the road improvement assistance system 1. Each step shown in FIG. 4 is executed by the processor 20 of the road improvement assistance system 1, which is a computer.

When the power of the road improvement assistance system 1 is turned on, the processing shown in FIG. 4 is started and repeatedly executed.

When the processing is started, the acquisition unit 30 first determines whether or not an instruction to start information generation has been received (S100). The instruction to start information generation is input via the input device 23 to the road improvement assistance system 1 by an operator of the road improvement assistance system 1.

Then, when an instruction to start information generation has not been received (NO in S100), the acquisition unit 30 returns to step S100, repeats the processing, and waits until receiving an instruction to start information generation. On the other hand, when an instruction to start information generation has been received (YES in S100), the acquisition unit 30 acquires a road surroundings image of a road of interest specified by the instruction to start information generation (S102). Next, the extraction unit 31 extracts a road feature group including at least one road feature from the acquired road surroundings image (S104).

The generation unit 32, based on the extracted road feature group, generates provision information, including an induction factor of interest and a countermeasure plan of interest, for the road of interest, by referring to the countermeasure planning database 11 (S106). For the generation of the provision information, the generation unit 32 may refer to the road feature database 3, correct the road feature group extracted from the road surroundings image, using the road features of the road of interest obtained from the road feature database 3, and generate the provision information based on the corrected road feature group.

The generation unit 32 also generates notification information that alerts traffic participants, based on the induction factor of interest (S108). Subsequently, the output unit 33 transmits and outputs the provision information to a predetermined organization (S110). Moreover, the output unit 33 outputs the notification information to the traffic participants (S112) and terminates the processing. After terminating the processing, the acquisition unit 30 newly starts the processing of step S100.

Note that step S102 and step S104 in FIG. 4 correspond to the extraction step in the present disclosure. Further, step S106 and step S108 correspond to the generation step and the output step, respectively, in the present disclosure.

### 3. Another Embodiment

In the above-described embodiment, the generation unit 32 generates the provision information using the LLM 121. Alternatively, the generation unit 32 may generate the provision information by performing a keyword search or semantic search on the countermeasure planning database 11, using a text group representing the road feature group of the road of interest as a query.

In the above-described embodiment, the road countermeasure data 111 in the countermeasure planning database 11 is data in which accident information, including an induction factor of an accident predicted from the road feature, is associated with a countermeasure plan for eliminating the induction factor of the accident. The “induction factor of an accident” is a factor that induces an accident, and specific details of the induced accident are not necessarily specified.

Not limited to the above, the accident information may include not only the induction factor of an accident predicted from the road feature, but also specific details of the accident that can be induced by the induction factor.

For example, the accident information may include an induction factor “Poor visibility ahead: beams and pillars of an elevated road may impair visibility.” and specific details of accidents, such as “collision with a vehicle from a crossing road” and “collision with a pedestrian appearing from a pedestrian crossing”, that may be induced by the induction factor.

In this case, the generation unit 32 can include, in the provision information, the specific details of accidents that can be induced by the induction factor of interest, in addition to the induction factor of interest and the countermeasure plan of interest. Moreover, instead of or in addition to calculating the possibility of occurrence and the risk level of an accident for each induction factor of interest, the generation unit 32 may calculate the possibility of occurrence and the risk level of a specific accident that may be induced by the induction factor of interest.

Further, instead of determining the priority level of each countermeasure plan of interest based on the risk level or the possibility of occurrence of an accident for each induction factor of interest, the generation unit 32 may determine the priority level of each countermeasure plan of interest based on the possibility of occurrence and the risk level of a specific detail of an accident that can be induced by the induction factor of interest. Furthermore, the generation unit 32 may generate the notification information, based on the specific detail of the accident that may be induced by the induction factor of interest.

Note that the present invention is not limited to the configurations of the above-described embodiments, and can be implemented in various modes within a range not departing from the gist of the invention.

### 4. Configurations Supported by the Embodiments

The above-described embodiments (and modified examples) support the following configurations.

(Configuration 1) A road improvement assistance system including: a countermeasure planning database that stores road countermeasure data in which information about road features that characterize a road, accident information including an induction factor of an accident predicted from the road features, and a countermeasure plan for eliminating the induction factor of the accident are associated with each other; an extraction unit that acquires an image of surroundings of a road of interest that is a road at a location of interest, and extracts a road feature group including at least one road feature of the road of interest from the image; a generation unit that, based on the road feature group extracted from the image, generates, as provision information, information including an induction factor of interest and a countermeasure plan of interest by referring to the countermeasure planning database, the induction factor of interest being an induction factor of an accident predicted for the road of interest, the countermeasure plan of interest being a countermeasure plan for eliminating the induction factor of interest; and an information output unit that outputs the provision information.

According to the road improvement assistance system of configuration 1, it is possible to efficiently propose, based on the road feature of the road of interest that is grasped from the image, an objective countermeasure plan in advance to prevent the occurrence of an accident on the road of interest.

(Configuration 2) The road improvement assistance system according to configuration 1, wherein the road features include information about a configuration, condition, traffic, and/or environment of a corresponding road.

According to the road improvement assistance system of configuration 2, it is possible to propose an objective countermeasure plan, based not only on the configuration of the road, but also on various road features that can affect the cognitive abilities of traffic participants.

(Configuration 3) The road improvement assistance system according to configuration 1 or 2, wherein the generation unit accesses a road feature database which stores geographical locations and road features of roads at the geographical locations in association with each other, corrects the road feature group extracted from the image, using the road features of the road of interest obtained from the road feature database, and generates the provision information using the corrected road feature group.

According to the road improvement assistance system of configuration 3, even when a road feature grasped from a current image of the road of interest contains a mistake, the mistake can be corrected using the information in the road feature database that has already been created, and, therefore, it is possible to present a more accurate countermeasure plan.

(Configuration 4) The road improvement assistance system according to any one of configurations 1 to 3, wherein, in the road countermeasure data stored in the countermeasure planning database, a predicted induction factor, risk level and possibility of occurrence of an accident, and a countermeasure plan for eliminating the induction factor of the accident are associated for each road feature or each combination of a plurality of road features, and the generation unit calculates a possibility of occurrence and a risk level of an accident for each of the induction factors of interest, using the road countermeasure data stored in the countermeasure planning database, and includes results of the calculation in the provision information.

According to the road improvement assistance system of configuration 4, it is possible to objectively grasp which of a plurality of induction factors of interest should receive more attention.

(Configuration 5) The road improvement assistance system according to configuration 4, wherein, when the provision information includes a plurality of countermeasure plans of interest, the generation unit determines a priority level of each of the countermeasure plans of interest, based on a risk level or a possibility of occurrence of an accident for each of the induction factors of interest corresponding to each of the countermeasure plans of interest, and includes the priority level of each of the countermeasure plans of interest in the provision information.

According to the road improvement assistance system of configuration 5, it is possible to effectively execute the countermeasure plans of interest, based on the priority levels, in order of the greatest effect on preventing the occurrence of accidents.

(Configuration 6) The road improvement assistance system according to any one of configurations 1 to 5, wherein the generation unit generates notification information that alerts traffic participants, based on the induction factor of interest, and the information output unit outputs the notification information to traffic participants traveling on the road of interest and in the surroundings of the road of interest.

According to the road improvement assistance system of configuration 6, it is possible to prevent the occurrence of accidents by alerting the traffic participants with the notification information until the countermeasure plan of interest is executed and completed.

(Configuration 7) A road improvement assistance method to be performed by a computer of a road improvement assistance system having a countermeasure planning database that stores road countermeasure data in which information about road features that characterize a road, accident information including an induction factor of an accident predicted from the road features, and a countermeasure plan for eliminating the induction factor of the accident are associated with each other, the road improvement assistance method including: an extraction step for acquiring an image of surroundings of a road of interest that is a road at a location of interest, and extracting a road feature group including at least one road feature of the road of interest from the image; a generation step for, based on the road feature group extracted from the image, generating, as provision information, information including an induction factor of interest and a countermeasure plan of interest by referring to the countermeasure planning database, the induction factor of interest being an induction factor of an accident predicted for the road of interest, the countermeasure plan of interest being a countermeasure plan for eliminating the induction factor of interest; and an output step for outputting the provision information.

According to the road improvement assistance method of configuration 7, it is possible to produce the same effect as configuration 1.

### REFERENCE SIGNS LIST

1 . . . road improvement assistance system, 2 . . . surveillance camera, 3 . . . road feature database, 4 . . . VLM server, 10 . . . assistance device, 11 . . . countermeasure planning database, 12 . . . LLM server, 20 . . . processor, 21 . . . memory, 22 . . . display device, 23 . . . input device, 30 . . . acquisition unit, 31 . . . extraction unit, 32 . . . generation unit, 33 . . . output unit, 40 . . . program, 111 . . . road countermeasure data, 121 . . . LLM, 401 . . . VLM, and NW . . . communication network.

1. A road improvement assistance system comprising:
a countermeasure planning database that stores road countermeasure data in which information about road features that characterize a road, accident information including an induction factor of an accident predicted from the road features, and a countermeasure plan for eliminating the induction factor of the accident are associated with each other;
an extraction unit that acquires an image of surroundings of a road of interest that is a road at a location of interest, and extracts a road feature group including at least one road feature of the road of interest from the image;
a generation unit that, based on the road feature group extracted from the image, generates, as provision information, information including an induction factor of interest and a countermeasure plan of interest by referring to the countermeasure planning database, the induction factor of interest being an induction factor of an accident predicted for the road of interest, the countermeasure plan of interest being a countermeasure plan for eliminating the induction factor of interest; and
an information output unit that outputs the provision information.

2. The road improvement assistance system according to claim 1, wherein the road features include information about a configuration, condition, traffic, and/or environment of a corresponding road.

3. The road improvement assistance system according to claim 1, wherein the generation unit accesses a road feature database which stores geographical locations and road features of roads at the geographical locations in association with each other, corrects the road feature group extracted from the image, using the road features of the road of interest obtained from the road feature database, and generates the provision information using the corrected road feature group.

4. The road improvement assistance system according to claim 1, wherein,
in the road countermeasure data stored in the countermeasure planning database, a predicted induction factor, risk level and possibility of occurrence of an accident, and a countermeasure plan for eliminating the induction factor of the accident are associated for each road feature or each combination of a plurality of road features, and
the generation unit calculates a possibility of occurrence and a risk level of an accident for each of the induction factors of interest, using the road countermeasure data stored in the countermeasure planning database, and includes results of the calculation in the provision information.

5. The road improvement assistance system according to claim 4, wherein, when the provision information includes a plurality of countermeasure plans of interest, the generation unit determines a priority level of each of the countermeasure plans of interest, based on a risk level or a possibility of occurrence of an accident for each of the induction factors of interest corresponding to each of the countermeasure plans of interest, and includes the priority level of each of the countermeasure plans of interest in the provision information.

6. The road improvement assistance system according to claim 1, wherein
the generation unit generates notification information that alerts traffic participants, based on the induction factor of interest, and
the information output unit outputs the notification information to traffic participants traveling on the road of interest and in the surroundings of the road of interest.

7. A road improvement assistance method to be performed by a computer of a road improvement assistance system having a countermeasure planning database that stores road countermeasure data in which information about road features that characterize a road, accident information including an induction factor of an accident predicted from the road features, and a countermeasure plan for eliminating the induction factor of the accident are associated with each other, the road improvement assistance method comprising:
an extraction step for acquiring an image of surroundings of a road of interest that is a road at a location of interest, and extracting a road feature group including at least one road feature of the road of interest from the image;
a generation step for, based on the road feature group extracted from the image, generating, as provision information, information including an induction factor of interest and a countermeasure plan of interest by referring to the countermeasure planning database, the induction factor of interest being an induction factor of an accident predicted for the road of interest, the countermeasure plan of interest being a countermeasure plan for eliminating the induction factor of interest; and
an output step for outputting the provision information.
